(19) United States
(12) Patent Application Publication
(10) Pub. No.: US 2012/0115056 A1
(43) Pub. Date: May 10, 2012

(54) PROPORTIONAL VALVE FOR CONTROL AND INTAKE OF A GASEOUS MEDIUM

(76) Inventor: Frank Meier, Stuttgart (DE)

(21) Appl. No.: 13/233,726

(22) Filed: Sep. 15, 2011

(30) Foreign Application Priority Data
Nov. 9, 2010 (DE) 102010043618.6

(51) Int. Cl. H01M 8/04; F16K 31/02

(52) U.S. Cl. 429/428; 251/129.01

(57) ABSTRACT

A proportional valve for controlling a gaseous medium, in particular hydrogen, including a valve housing, an ejector unit, which is situated on the valve housing, having an inflow area, to which a first gaseous medium is fed under pressure, having an intake area, at which a second gaseous medium is present, and having a mixing tube area, from which a mixture of the first and second gaseous medium emerges, the intake area being situated between the inflow area and the mixing tube area, having an actuator, and a closure element, which is connected to the actuator, and unblocks and closes a passage opening, the passage opening being situated between the inflow area and the intake area of the ejector unit.

### FIELD OF THE INVENTION

The present invention relates to a proportional valve for control and intake of a gaseous medium, in particular hydrogen, having an ejector unit, in particular for use in vehicles having a fuel cell drive.

### BACKGROUND INFORMATION

In addition to liquid fuels, gaseous fuels will play an increasingly greater role in the motor vehicle segment in the future. In particular in vehicles driven by fuel cells, flows of hydrogen gas must be controlled. In this case, the gas flows are no longer controlled discontinuously as in the case of the injection of liquid fuel, but instead proportional valves in particular are used which adjust an opening cross section of the valve as a function of a desired driving power.

An ejector is described in U.S. Patent Publication No. 2009/0155092 in which the flow cross section of a passage opening of a nozzle unit of an ejector is adjusted with the aid of a mechanical regulating unit having multiple diaphragms. This regulates the feed of the gaseous medium from a tank as well as an intake of the recycled gaseous medium from the fuel cell. Apart from insufficient precision, this regulation also has an unsatisfactory responsiveness.

### SUMMARY OF THE INVENTION

The proportional valve according to the present invention for control and intake of a gaseous medium has the advantage over the related art that an ejector unit is situated on the valve housing and an actuator activates a closure element attached to the valve housing which unblocks and closes a passage opening. In this case, the passage opening is situated between an inflow area, at which a first gaseous medium is fed, and an intake area of the ejector unit, at which a second gaseous medium is present. This results in a more exact adjustment of the flow cross section of the passage opening. This makes it possible to regulate the continuous and demand-based metering of the second gaseous medium, in particular to an anode of the fuel cell corresponding to the consumed or dissipated volume of the second gaseous medium in a considerably more precise way, and significantly improve the responsiveness. Furthermore, the proportional valve according to the present invention has a simple and compact design.

According to a preferred embodiment of the present invention, a control unit is also provided which controls the actuator based on a pulse width modulation. The pulse width-modulated signal present at the actuator makes it possible for the closure element to adjust the flow cross section of the passage opening rapidly and with high precision. Moreover, it is possible to provide a simple and cost-effective control, whose simple structure requiring little space also makes it integratable without difficulty into a main control unit of the vehicle.

In another advantageous embodiment of the present invention, at least one pressure sensor is provided which is connected to the control unit and is situated at the intake area and/or at the outlet of the mixing tube area. Based on the detected pressure values, it is thus simultaneously possible to provide in particular an improved regulation of the anode pressure, which ensures a continuous and precise adjustment of the opening degree of the passage opening.

Furthermore, the ejector unit preferably includes a heating device for heating the ejector unit. The heating device may be operated with the aid of electrical energy or, alternatively, with the aid of a coolant of a fuel cell. The heating of entire ejector unit 10 prevents icing to the greatest degree possible or makes rapid deicing possible, whereby high operating reliability in a constant temperature range may be ensured.

Furthermore, the present invention relates to a fuel cell system, including a fuel cell and a proportional valve according to the present invention.

Preferably, the fuel cell includes an anode area and a cathode area, the mixing tube area being connected to the anode area with the aid of a connecting line, and a return line is provided which connects the anode area of the fuel cell to the intake area of the ejector unit. This makes possible a reliable, superstoichiometric feed of the first and second gaseous media via the connecting line into the anode area as well as an operationally reliable return of the second gaseous medium via the return line into the intake area of the ejector unit. As a result, it is reliably possible to prevent catalytic converter damage caused by a localized depletion of the gaseous medium in subareas of the fuel cell. Moreover, it is thus possible to prevent an unnecessary venting of the unused gaseous medium from the anode area to the outside or avoid it to the greatest extent possible, resulting in lower fuel consumption.

According to a preferred embodiment of the present invention, a pressure in the connecting line is detected by a first pressure sensor and/or a pressure in the return line is detected by a second pressure sensor. It is further preferred that the fuel cell system includes a control unit for controlling a pressure in the anode area of the fuel cell, the control unit being connected to the proportional valve. It is thus possible to use the detected pressure values and a control algorithm stored in the control unit to implement a precise, simple and cost-effective pressure regulation in the anode circuit of the fuel cell.

The fuel cell system preferably further includes a tank for storing the first gaseous medium, an inflow line which connects the tank to the inflow area of the ejector unit, and a pressure regulating valve which is situated in the inflow line in order to set a pressure in the inflow area of the ejector unit. This ensures an operationally reliable reduction of pressure from the high pressure level in the tank into a defined pressure range before the first gaseous medium is fed to the proportional valve.

According to a preferred embodiment of the present invention, the fuel cell system further includes a heating line which conducts heat from the fuel cell to the ejector unit of the proportional valve. Continuous heating is thus ensured, making a homogeneous function of the proportional valve in a suitable, constant temperature range possible. Moreover, an additional cooling of the fuel cell is provided in a simple manner.

### BRIEF DESCRIPTION OF THE DRAWINGS

FIG. 1 shows a schematic sectional view of a proportional valve according to a preferred exemplary embodiment of the present invention.

FIG. 2 shows a schematic diagram of a fuel cell system according to the present invention and the proportional valve of FIG. 1.

### DETAILED DESCRIPTION

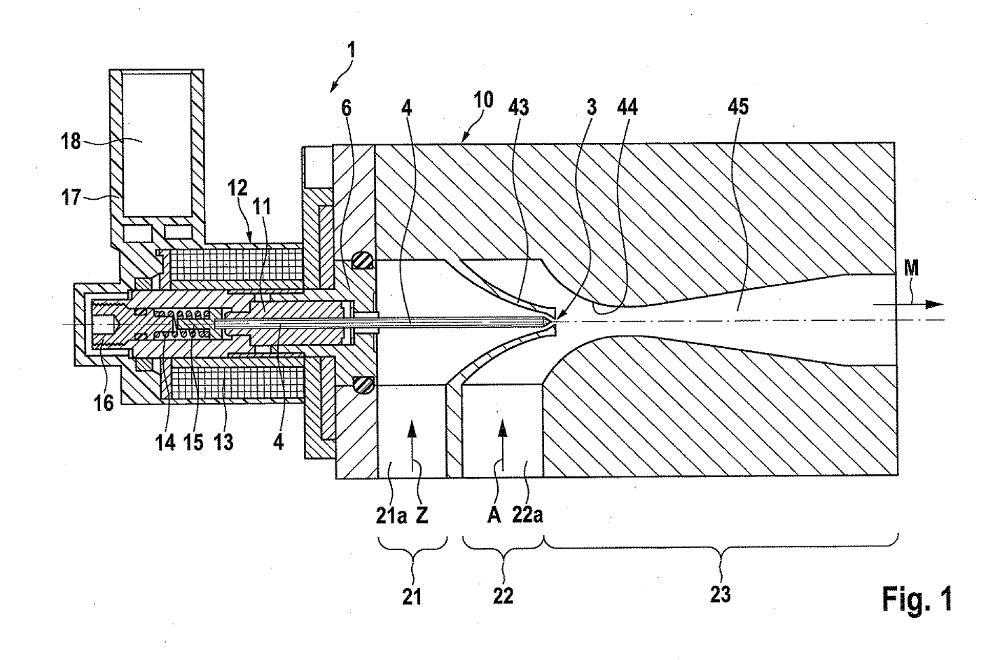

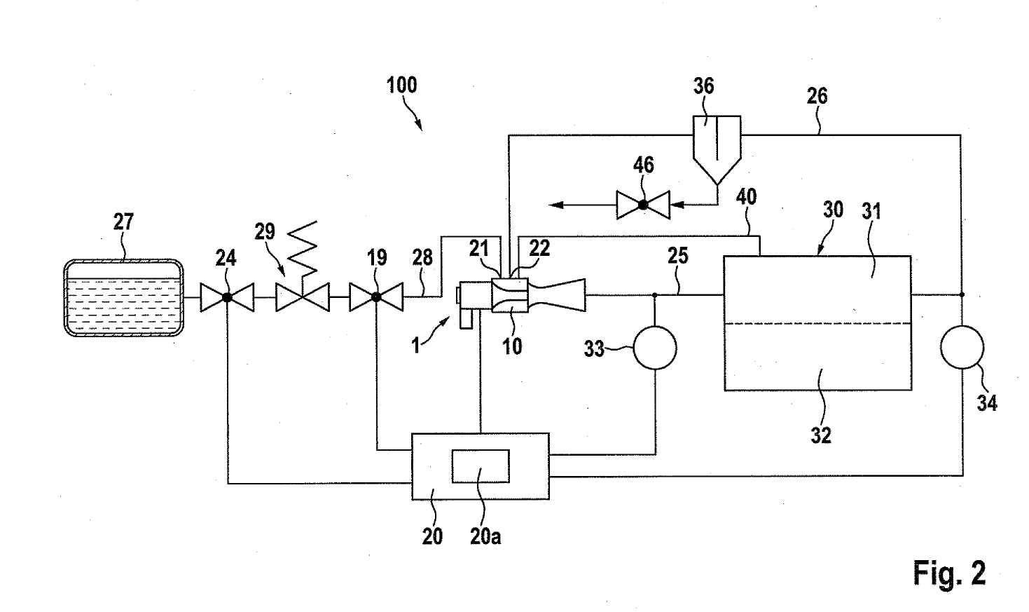

A proportional valve 1 for controlling a gaseous medium will be described in detail below with reference to FIGS. 1 and 2 according to a preferred exemplary embodiment. Proportional valve 1 shown is used for controlling gaseous hydrogen which is fed to a fuel cell 30 in a vehicle. In this connection, proportional valve 1 alone according to the present invention will be described below with reference to FIG. 1 and proportional valve 1 in combination with a connected fuel cell in a fuel cell system will be described with reference to FIG. 2.

As is apparent from FIG. 1, proportional valve 1 includes a valve housing 6, an actuator 12 having an armature 11 and a solenoid 13 and a closure element 4 connected to actuator 12. Closure element 4 is connected directly to armature 11 and is designed as a needle. A closing spring 14 is connected to closure element 4 via a spring seat 15. Reference numeral 16 denotes a setting bolt for setting a restoring force of closing spring 14. Solenoid 13 is attached to valve housing 6 in an overmold 17 made of plastic. An electrical plug connector 18 is provided to the side of proportional valve 1.

As FIG. 1 also shows, an ejector unit 10 is situated on valve housing 6, an inflow area 21, an intake area 22 and a mixing tube area 23 being formed in the interior of the ejector unit. Inflow area 21 has an inflow opening 21a, from which a first gaseous medium from a tank 27, which is not shown here (see FIG. 2), is fed under pressure in the direction of an arrow Z. Intake area 22 has an intake opening 22a, at which a second gaseous medium from an anode area 31 of a connected fuel cell 30 (see FIG. 2) is present and may be taken in in the direction of an arrow A. A propelling nozzle 43 having a passage opening 3 is formed between inflow area 21 and intake area 22, the propelling nozzle being unblocked and closed by closure element 4 when proportional valve 1 is activated. A collecting nozzle 44 and a diffuser 45 are formed in mixing tube area 23. When passage opening 3 is open, the first gaseous medium supplied from inflow area 21 flows into intake area 22 under high pressure. Utilizing the energy of the first gaseous medium supplied at higher pressure, the second gaseous medium located in intake area 21 is taken in through intake opening 22a against the present pressure difference and is ejected from mixing tube area 23 as a gas mixture together with the first gaseous medium in the direction of an arrow M.

As is apparent from FIG. 2, mixing tube area 23 of ejector unit 10 is connected via a connecting line 25 to fuel cell 30, which includes an anode area 31 and a cathode area 32. Moreover, a return line 26 is provided which connects anode area 31 of fuel cell 30 to intake area 22 of ejector unit 10. Return line 26 may be used to return the second gaseous medium produced in anode area 31 during operation of fuel cell 30 to intake area 22, the gaseous medium being primarily a mixture of hydrogen, nitrogen and water vapor. Furthermore, a branch 36 having a shutoff valve 46 is provided in return line 26 in order to be able to release the gaseous medium located in return line 26 to the outside if necessary.

A first pressure sensor 33 is provided in connecting line 25 for detecting the pressure in connecting line 25. Furthermore, a second pressure sensor 34 is provided in return line 26 for detecting the pressure in return line 26. The detected pressure values are fed to a control unit 20 connected to proportional valve 1 for controlling the pressure in anode area 31 of fuel cell 30. Based on a pulse width modulation 20a, control unit 20 controls actuator 12, which activates closure element 4, so that a flow cross section of passage opening 3 is changed in such a way that the gas flow fed to fuel cell 30 is set according to demand.

As is also apparent from FIG. 2, the first gaseous medium stored in tank 27 is fed to inflow area 21 of ejector unit 10 via an inflow line 28. A mechanical pressure regulating valve 29 is provided in inflow line 28, the pressure regulating valve being connected to control unit 20 in order to set a pressure in inflow area 21 of ejector unit 10. Moreover, a first shutoff valve 24 is situated between pressure regulating valve 29 and tank 27 and a second shutoff valve 19 is situated between pressure regulating valve 29 and ejector 10. Shutoff valves 24, 19 are also connected to control unit 20 in order to, if necessary, interrupt the inflow of the first gaseous medium from tank 27 to the pressure regulating valve or the further inflow to ejector unit 10.

Moreover, a heating line 40 is provided between anode area 31 of fuel cell 30 and ejector unit 10, the heating line conducting the heat in a coolant from a circuit of fuel cell 30, which is not shown here, for heating ejector unit 10. The coolant is heated in fuel cell 30 and directed via heating line 40 to ejector unit 10 where it heats ejector unit 10 and is returned to fuel cell 30 using a return line which is not shown.

Proportional valve 1 for controlling a gaseous medium thus has the advantage that the feed of the first gaseous medium and the metering of the second gaseous medium into anode area 31 of fuel cell 30 are possible with the aid of the electronically controlled adjustment of the flow cross section of passage opening 3 while at the same time the anode pressure may be regulated substantially more precisely. This significantly improves the operating reliability and service life of the connected fuel cell, since hydrogen is constantly supplied in a superstoichiometric proportion. Moreover, it is also possible to prevent consequential damages, for example, damages to a downstream catalytic converter.

What is claimed is:

1. A proportional valve for controlling a gaseous medium, comprising:
a valve housing;
an ejector unit situated on the valve housing, the ejector unit having an inflow area, to which a first gaseous medium is fed under pressure, having an intake area, at which a second gaseous medium is present, and having a mixing tube area, from which a mixture of the first and second gaseous medium emerges, the intake area being situated between the inflow area and the mixing tube area;
an actuator; and
a closure element, which is connected to the actuator, and unblocks and closes a passage opening, the passage opening being situated between the inflow area and the intake area of the ejector unit.

2. The proportional valve according to claim 1, wherein the gaseous medium is hydrogen.

3. The proportional valve according to claim 1, further comprising a control unit for controlling the actuator based on a pulse width modulation.

4. The proportional valve according to claim 3, further comprising at least one pressure sensor which is connected to the control unit and is situated in the intake area and/or at an outlet of the mixing tube area.

5. The proportional valve according to claim 1, wherein the ejector unit includes a heating device for heating the ejector unit.

6. The proportional valve according to claim 1, wherein the actuator is a magnetic actuator, the magnetic actuator including an armature connected to the closure element.

7. A fuel cell system comprising a fuel cell and a proportional valve, the proportional valve including:
a valve housing;
an ejector unit situated on the valve housing, the ejector unit having an inflow area, to which a first gaseous medium is fed under pressure, having an intake area, at which a second gaseous medium is present, and having a mixing tube area, from which a mixture of the first and second gaseous medium emerges, the intake area being situated between the inflow area and the mixing tube area;
an actuator; and
a closure element, which is connected to the actuator, and unblocks and closes a passage opening, the passage opening being situated between the inflow area and the intake area of the ejector unit.

8. The fuel cell system according to claim 7, wherein the fuel cell has an anode area and a cathode area, and the mixing tube area is connected to the anode area with the aid of a connecting line, a return line connecting the anode area of the fuel cell to the intake area of the ejector unit.

9. The fuel cell system according to claim 8, wherein a pressure in the connecting line is detected by a first pressure sensor and a pressure in the return line is detected by a second pressure sensor.

10. The fuel cell system according to claim 8, further comprising a control unit for controlling a pressure in the anode area of the fuel cell, the control unit being connected to the proportional valve.

11. The fuel cell system according to claim 10, further comprising a tank for storing the first gaseous medium, an inflow line, which connects the tank to the inflow area of the ejector unit, and a pressure regulating valve, which is situated in the inflow line and is connected to the control unit in order to set a pressure in the inflow area of the ejector unit.

12. The fuel cell system according to claim 7, further comprising a heating line, which conducts heat from the fuel cell to the ejector unit of the proportional valve.
